(19) United States
(12) Patent Application Publication
(10) Pub. No.: US 2025/0219665 A1
(43) Pub. Date: Jul. 3, 2025

(54) RECEIVING DEVICE, RECEIVING METHOD, AND PROGRAM

(71) Applicant: SONY SEMICONDUCTOR SOLUTIONS CORPORATION, KANAGAWA (JP)

(72) Inventors: HITOSHI TOMIYAMA, KANAGAWA (JP); HIDEYA KITAYAMA, KANAGAWA (JP)

(21) Appl. No.: 18/849,517

(22) PCT Filed: Mar. 13, 2023
(86) PCT No.: PCT/JP2023/009514

§ 371 Date: Sep. 22, 2024

(30) Foreign Application Priority Data
Mar. 30, 2022 (JP) 2022-055244

(51) Int. Cl. H04B 1/10; H04B 1/16

(52) U.S. Cl. CPC H04B 1/10; H04B 1/16

(57) ABSTRACT

The present technique relates to a receiving device, a receiving method, and a program that reduce the effects of interfering waves and enable a desired wave to be received in a favorable state. The receiving device includes: a low-noise amplifying unit into which a received signal is input; and a search processing unit that searches for an interfering wave and sets a gain of the low-noise amplifying unit to reduce an effect of the interfering wave. When the gain is changed, a gain, at which a sensitivity of a noise figure of the interfering wave and a sensitivity of third intermodulation distortion (IM3) of the interfering wave intersect, is set to the gain of the low-noise amplifying unit. The present technique can be applied in a receiving device that receives weak signals.

### TECHNICAL FIELD

The present technique relates to a receiving device, a receiving method, and a program, and relates, for example, to a receiving device, a receiving method, and a program capable of reception in which the effects of interfering waves are reduced.

### BACKGROUND ART

Recent years have seen the promotion of Internet of Things (IoT) technology, in which a large number of items are connected to the Internet. Using Low Power Wide Area (LPWA), Low Power Wide Area Network (LPWAN), and the like, which are wireless communication technologies enabling long-distance data communication while consuming less power, has been proposed for use in IoT technology.

In wireless communication, the effects of interference waves are rising, and PTL 1 and the like propose reducing the effects of interference waves. PTL 1 proposes, in a receiver capable of processing a plurality of frequencies, selecting, as a frequency to be used, a frequency that is not significantly affected by interference waves, based on information on and a level of a frequency that includes the interference waves.

### CITATION LIST

### Patent Literature

### [PTL 1]

Japanese Unexamined Patent Application Publication No.2007-312274

### SUMMARY

### Technical Problem

As proposed in PTL 1, when a frequency that is not significantly affected by interference waves is selected as the frequency to use, it is necessary that communication for changing the frequency be performed on both the transmitting and receiving sides, and it is also necessary that a cumbersome procedure be performed on both the transmitting and receiving sides. It would therefore be preferable that reception in which the effects of interference waves have been reduced, be performed without performing communication between the transmitting side and the receiving side.

The present technique has been made in light of such circumstances and makes it possible to perform reception that reduces the effects of interference waves.

### Solution to Problem

A receiving device according to one aspect of the present technique is a receiving device including: a low-noise amplifying unit into which a received signal is input; and a search processing unit that searches for an interfering wave and sets a gain of the low-noise amplifying unit to reduce an effect of the interfering wave.

A receiving method according to one aspect of the present technique is a receiving method including: by a receiving device, which includes a low-noise amplifying unit into which a received signal is input, searching for an interfering wave and setting a gain of the low-noise amplifying unit to reduce an effect of the interfering wave.

A program according to one aspect of the present technique is a program for causing a computer, which controls a receiving device, the receiving device including a low-noise amplifying unit into which a received signal is input, to perform processing including a step of searching for an interfering wave and setting a gain of the low-noise amplifying unit to reduce an effect of the interfering wave.

The receiving device, the receiving method, and the program according to one aspect of the present technique include the low-noise amplifying unit into which a received signal is input. An interfering wave is searched for, and a gain of the low-noise amplifying unit is set to reduce an effect of the interfering wave.

Note that the receiving device may be an independent device or may be an internal block, which constitutes a single device.

Note also that the program can be transmitted via a transmission medium or recorded onto a recording medium and provided in such a form.

### BRIEF DESCRIPTION OF DRAWINGS

FIG. 1 is a diagram illustrating the configuration of an embodiment of an information processing system to which the present technique is applied.

FIG. 2 is a diagram illustrating interfering waves.

FIG. 3 is a diagram illustrating an example of the configuration of a terminal.

FIG. 4 is a diagram illustrating a reception timing.

FIG. 5 is a diagram illustrating a timing at which to perform search processing.

FIG. 6 is a flowchart illustrating processing by a terminal.

FIG. 7 is a diagram illustrating an example of a receiver characteristic table.

FIG. 8 is a diagram illustrating an interfering wave search method.

FIG. 9 is a diagram illustrating an example of an interfering wave information table.

FIG. 10 is a diagram illustrating IM3.

FIG. 11 is a diagram illustrating a result of calculating IM3.

FIG. 12 is a diagram illustrating an example of a value of IM3 with respect to interfering waves.

FIG. 13 is a diagram illustrating a gain setting method.

FIG. 14 is a diagram illustrating a relationship between LNA gain and IIP3.

FIG. 15 is a diagram illustrating a relationship between noise and IM3.

FIG. 16 is a diagram illustrating a recording medium.

### DESCRIPTION OF EMBODIMENT

Hereinafter, modes for carrying out the present technique (hereinafter referred to as “embodiments”) will be described.

### <Configuration of Information Processing System>

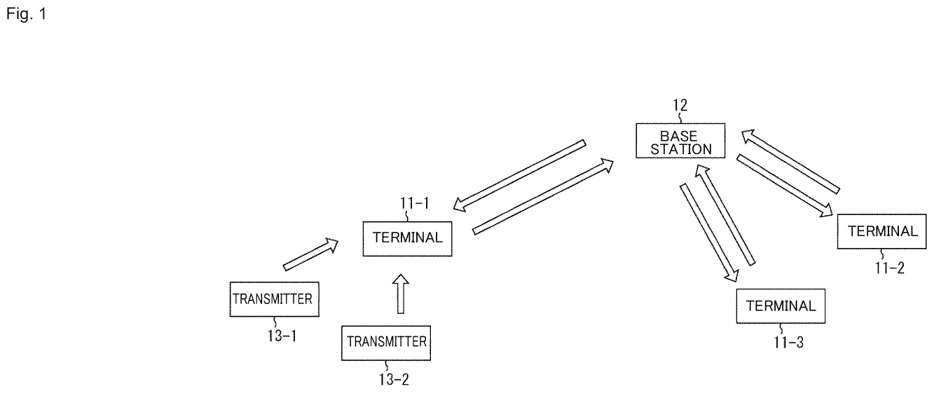

FIG. 1 is a diagram illustrating the configuration of an embodiment of an information processing system to which the present technique is applied.

An information processing system 1 is configured including terminals 11-1 to 11-3 and a base station 12. The information processing system 1 is a system in which data is exchanged between the terminals 11-1 to 11-3 and the base station 12. The information processing system 1 can be applied to an Internet of Things (IoT)—related system, for example. The terminals 11 and the base station 12 communicate using, for example, Low Power Wide Area (LPWA), Low Power Wide Area Network (LPWAN), or the like.

In the following descriptions, the terminals 11-1 to 11-3 will be referred to simply as “terminals 11” when there is no need to distinguish among the individual terminals. The same applies to other parts as well.

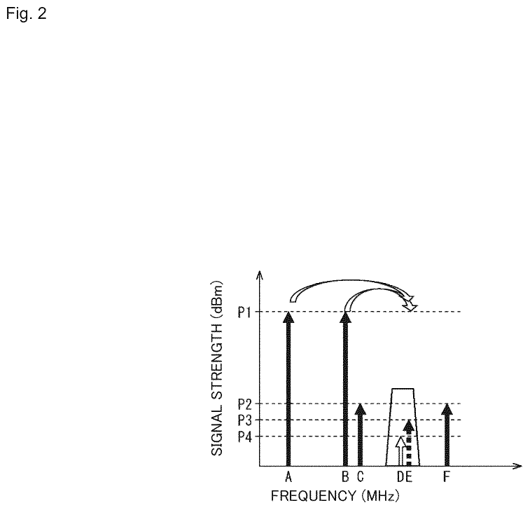

A transmitter 13-1 and a transmitter 13-2 are devices that are not included in the information processing system 1. The transmitter 13-1 and the transmitter 13-2 are devices that transmit signals that adversely affect the communication by the terminal 11-1 with the base station 12. Signals emitted by the transmitters 13 will be called “interfering waves” hereinafter. The effects of the interfering waves emitted by the transmitter 13-1 and the transmitter 13-2 on the terminal 11-1 will be described with reference to FIG. 2.

In FIG. 2, the horizontal axis represents frequency, and the vertical axis represents signal strength. The transmitter 13-1 transmits a signal at a frequency A and a signal strength P1 (called “interfering wave A”). The transmitter 13-2 transmits a signal at a frequency B and the signal strength P1 (called “interfering wave B”).

Although not illustrated in FIG. 1, a transmitter 13-3 transmits a signal at a frequency C and a signal strength P2 (called “interfering wave C”), and a transmitter 13-4 transmits a signal at a frequency F and a signal strength P2(called “interfering wave F”).

A signal used by the terminal 11-1 for communication with the base station 12 is a signal at a frequency D and a signal strength P4. A signal received by the terminal 11-1 will be referred to as a “desired wave” as appropriate. In the drawing, a trapezoid surrounding an arrow representing a signal at the frequency D represents a reception band of the terminal 11-1.

A modulated wave is produced by intermodulation of the interfering wave A and the interfering wave B. This modulated wave is the signal indicated by the broken line in FIG. 2, and is a signal at a frequency E and a signal strength P3 (referred to as a “modulated wave E”). Because the modulated wave E is in the reception band of the terminal 11-1, it is difficult to attenuate the modulated wave E with a predetermined filter, and the modulated wave E therefore affects the reception of the desired wave.

The signal strengths increase in the order of the signal strength P1, the signal strength P2, the signal strength P3, and the signal strength P4. For example, if a signal having a signal strength of at least 60 db is assumed to adversely affect the terminal 11-1 due to the stated intermodulation, in the situation illustrated in FIG. 2, the interfering wave A and interfering wave B correspond to interfering waves that have an adverse effect, and the interfering wave C and the interfering wave D do not correspond to the interfering waves that have an adverse effect. In such a case, it is desirable to eliminate the adverse effects of the interfering wave A and the interfering wave B such that the desired wave can be received favorably.

The communication distance between the terminals 11 and the base station 12 is long at, for example, tens of kilometers, and the output of the transmitted signal from the base station 12 is also short at hundreds of mv. As such, the strength of the received signal that reaches the terminal side (the signal strength P4, in FIG. 2) is low, and may be lower than a level of noise such as thermal noise. Because the desired wave is a weak radio wave, it is desirable to reduce the effects of the modulated wave E and the like as much as possible such that the desired wave can be received favorably.

In a situation such as that caused by the effects of interfering waves, such as that illustrated in FIG. 2, changing the frequency of the desired wave to a frequency in a band that does not include the modulated wave E, and then transmitting and receiving the signal with the base station 12, has been proposed in the past. However, the base station 12 handles a large number of terminals 11, and it has been necessary to perform communication for changing the reception frequency of the terminals 11 one terminal at a time. It has also been necessary to perform a cumbersome procedure in both the terminals 11 and the base station 12.

The terminal 11, which will be described below, can reduce the effects of interfering waves and improve the reception of the desired wave without making such a frequency change.

### <Terminal Configuration>

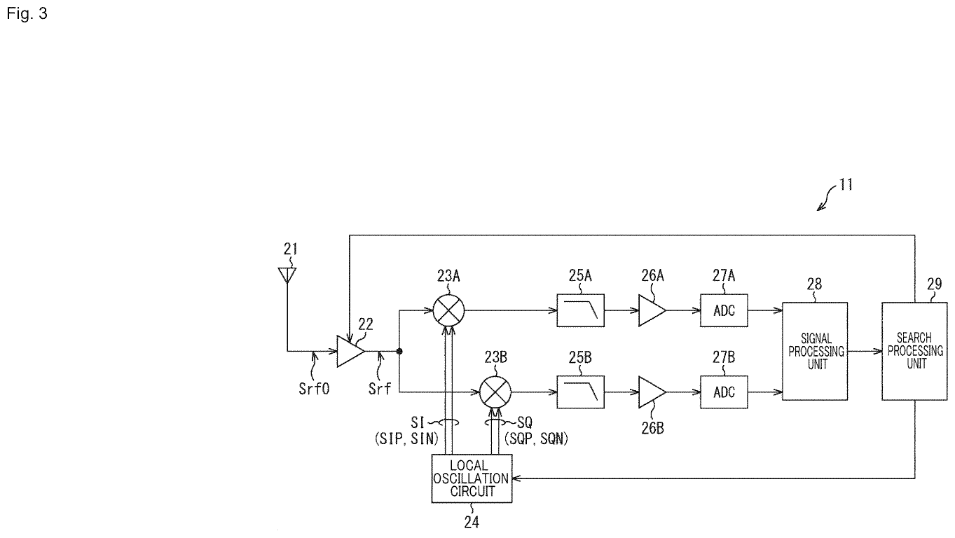

FIG. 3 illustrates an example of the configuration of the terminal 11. Here, the descriptions will be continued assuming a direct conversion-type receiving device that receives an orthogonally-modulated signal as an example of the configuration of the terminal 11.

Note that the present technique can be applied not only when the terminal 11 is a device that only receives, but also when the terminal 11 is a device that both receives and transmits. The following will describe the configuration of the parts of the terminal 11 involved in reception, and will omit descriptions of the configuration of the parts involved in transmission.

The terminal 11 includes an antenna 21, a low-noise amplification circuit 22, mixer circuits 23A and 23B, a local oscillation circuit 24, Low Pass Filters (LPFs) 25A and 25B, amplification circuits 26A and 26B, Analog to Digital Converters (ADCs) 27A and 27B, a signal processing unit 28, and a search processing unit 29.

The low-noise amplification circuit 22 is a circuit that amplifies a weak signal Srf0, received by the antenna 21 and having a high-frequency component of a frequency frf, and outputs the amplified signal as a signal Srf. In the terminal 11, providing the low-noise amplification circuit 22 in the first stage makes it possible to increase the signal-to-noise ratio (S/N ratio) of the terminal 11 as a whole, which makes it possible to receive weak radio waves. The low-noise amplification circuit 22 is configured to be capable of operating at a low power supply voltage.

The local oscillation circuit 24 is an oscillation circuit that generates signals SI (SIP, SIN) and SQ (SQP, SQN) having the same frequency flo as the carrier wave, and is constituted, for example, by a frequency synthesizer using a Phase Locked Loop (PLL). The signal SI is for extracting an in phase component from the signal Srf in the mixer circuit 23A (described later), and the signal SQ is for extracting a quadrature component from the signal Srf in the mixer circuit 23B (described later). The signal SIP and the signal SIN have phases 180 degrees different from each other, and the signal SQP and the signal SQN have phases 180 degrees different from each other. In addition, the phase of the signal SQP is 90 degrees behind that of the signal SIP, and the phase of the signal SQN is 90 degrees behind that of the signal SIN.

The mixer circuit 23A extracts the in-phase component of the signal Srf by multiplying the output signal Srf from the low-noise amplification circuit 22 and the signals SI (SIP, SIN) and downconverting the product. The mixer circuit 23B extracts the quadrature component of the signal Srf by multiplying the output signal Srf from the low-noise amplification circuit 22 and the signals SQ (SQP, SQN) and downconverting the product.

The LPFs 25A and 25B are low-pass filters for removing unnecessary frequency components, such as a frequency (frf+flo) component, that arise when multiplying the signal Srf by the signals SI and SQ in the mixer circuits 23A and 23B, respectively. The amplification circuits 26A and 26B are circuits that amplify the output signals from the LPFs 25A and 25B, respectively. The ADCs 27A and 27B have a function of binarizing the output signals from the amplification circuits 26A and 26B, respectively, to convert the signals into digital signals.

The signal processing unit 28 is a circuit that, based on the digital signal according to the in phase component supplied from the ADC 27A and the digital signal according to the quadrature component supplied from the ADC 27B, performs predetermined signal processing (baseband processing) in accordance with a communication protocol, and supplies the result to the search processing unit 29.

The search processing unit 29 performs processing for searching for interfering waves (described below), and performs processing for adjusting the gain of the low-noise amplification circuit 22.

### <Timing of Search Processing>

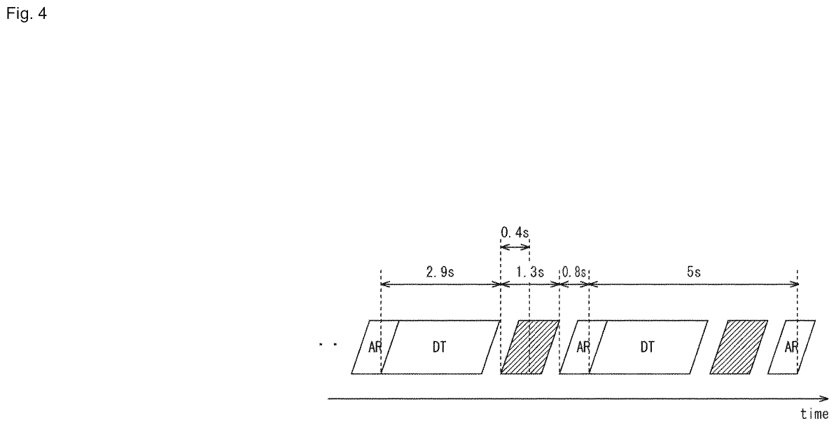

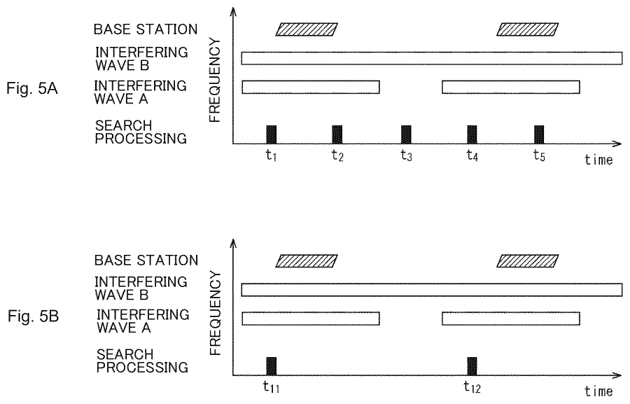

The timing at which the search processing unit 29 performs the search processing will be described with reference to FIGS. 4 and 5. FIG. 4 is a diagram illustrating transitions over time in the communication method performed by the terminal 11.

In the communication between the terminal 11 and the base station 12, transmission and reception are performed alternately using the same frequency. In the figure, the quadrangles without hashing represent uplink (transmission), and the quadrangles containing hatching represent downlink (reception). As illustrated in FIG. 4, a downlink signal is transmitted every 5 seconds, 0.4 seconds of which includes the signal to be received. The numerical values in FIG. 4 are merely examples, and the values are not intended to be limited thereto.

To better receive the downlink signal, the terminal 11 searches for interfering waves before receiving the downlink signal, and performs processing to reduce the effect of the interfering waves detected as a result of the search.

FIG. 5 is a diagram illustrating the timing at which the search processing is performed. In A of FIG. 5, the horizontal axis represents time, and the vertical axis represents the frequency. In the situation illustrated in FIG. 2, the frequency increases in the order of the desired wave D (the signal from the base station 12), the interfering wave B, and the interfering wave A. A in FIG. 5 therefore also assumes such an arrangement, in order from the top. The interfering wave B is output continuously, and the interfering wave A is output during a time period that overlaps with the downlink signal.

As described with reference to FIG. 4, the transmitted signal from the base station 12 is transmitted (received) at predetermined intervals, such as every 5 seconds. The search processing is performed at a predetermined period, such as when the timing of the transmission is not recognized by the terminal 11, or when the timing of the transmission is undetermined. In the example illustrated in A of FIG. 5, the search processing is performed at time t1, time t2, time t3, time t4, and time t5.

The result of the search processing performed at time t1 is applied, and the processing for the desired wave D received after time t1 is then performed. Likewise, the result of the search processing performed at time t4 is applied, and the processing for the desired wave D received after time t4 is then performed.

The search processing performed at time t5 is performed while receiving the signal from the base station. In such a case, when the signal from the base station 12 is received, the search processing may not be executed (may be stopped) even when the predetermined interval has passed the time when the search processing is to be performed has arrived.

B in FIG. 5 is a diagram illustrating a timing of the search processing when the timing at which the transmission signal is transmitted from the base station 12 is recognized by the terminal 11. The terminals 11 performs the search processing at a point in time before the signal from the base station 12 is received, which in B of FIG. 5 is time t11 and time t12. The search processing may be performed immediately before receiving the signal from the base station 12, or may be performed earlier by a predetermined length of time.

The result of the search processing performed at time t11 is applied, and the processing for the desired wave D received after time t11 is then performed. Likewise, the result of the search processing performed at time t12 is applied, and the processing for the desired wave D received after time t12 is then performed.

As described with reference to B of FIG. 5, even if the search processing is performed at the timing at which the signal from the base station 12 is received, the search processing will basically be performed periodically. As illustrated in FIG. 4, the signal is transmitted from the base station 12 periodically, and thus even if the search processing is performed at the timing at which the signal is received by the terminal 11, the search processing will be performed periodically.

When the search processing is performed at the timing at which the signal from the base station 12 is received, situations where the period of the transmission of the signal from the base station 12 is changed and the like can be handled, and the number of times the search processing is performed can be appropriately set. This makes it possible to reduce the power and processing time required for the search processing.

### <Search Processing Performed by Terminal 11>

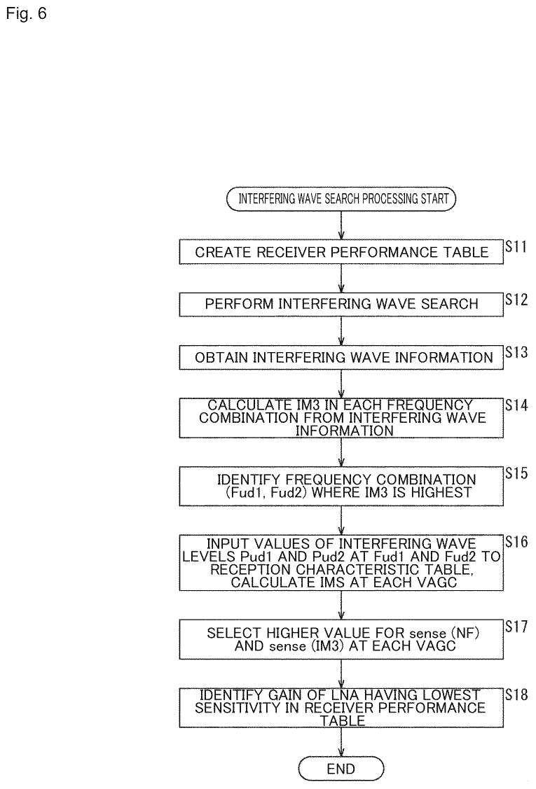

The interfering wave search processing performed by the terminal 11 will be described next with reference to the flowchart illustrated in FIG. 6. The interfering wave search processing is executed by the search processing unit 29 (FIG. 3).

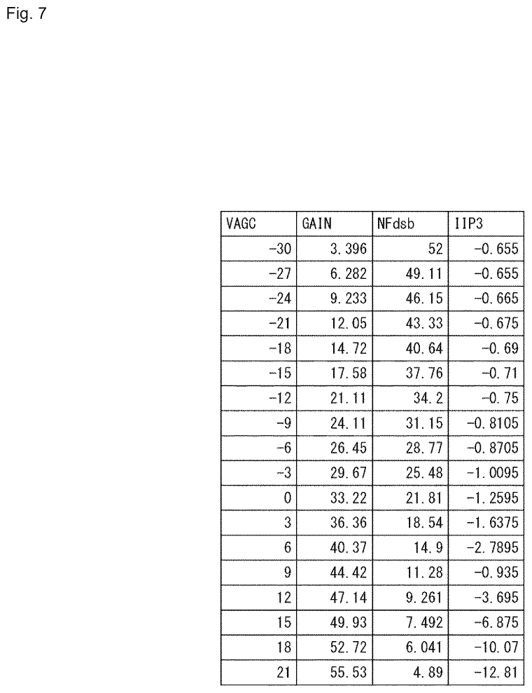

In step S11, a receiver performance table is created. The receiver performance table is a table related to the performance related to the receiving function of the terminal 11, and is a table such as that illustrated in FIG. 7, for example. Referring to the table in FIG. 7, the gain of the low-noise amplification circuit 22 (VAGC), the output gain from the LPF 25 (GAIN), a noise figure (NFdsb), and the intermodulation distortion intercept point (IIP3) are provided as items in the receiver performance table.

The low-noise amplification circuit 22 is configured to be capable of changing the gain from −30 dB to 21 dB, in 3-dB increments. As a result of searching for interfering waves, the gain of the low-noise amplification circuit 22 is set to a gain at which interfering waves are less likely to have an effect, and the gain that can be set is indicated in the VAGC column. GAIN, NFdsb, and IIP3 are associated and denoted for each gain.

The receiver performance table illustrated in FIG. 7 in obtained when the circuit is designed and is stored in the search processing unit 29 (FIG. 3). Referring to the receiver performance table illustrated in FIG. 7, when the VAGC is “−30”, for example, a gain of “3.396”, an NFdsb of “52”, and an IIP3 is “−0.655” are denoted in association therewith. When the VAGC is “−27”, for example, a gain of “6.282”, an NFdsb of “49.11”, and an IIP3 is “−0.655” are denoted in association therewith. Hereinafter, in the receiver performance table, the GAIN, NFdsb, and IIP3 according to the VAGC are denoted in association therewith in the same manner.

The receiver performance table is obtained when the circuit is designed and is stored in the search processing unit 29, and the processing of step S11 can therefore be omitted after the table has been stored. The processing performed each time the interfering wave search processing is performed is the processing from step S12 on.

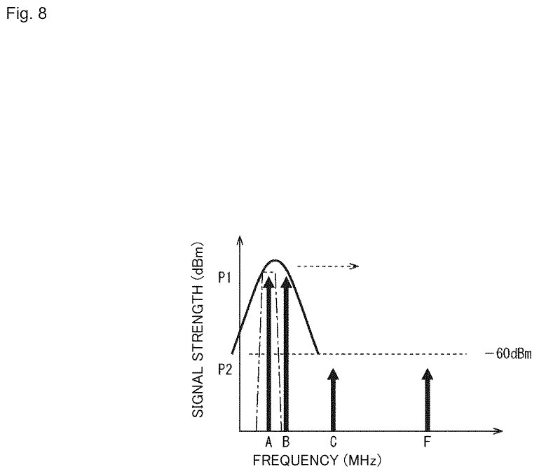

In step S12, the interfering wave search is performed. An interfering wave search method will be described with reference to FIG. 8. Although FIG. 8 is the same as the graph in FIG. 2, only the interfering wave A, the interfering wave B, the interfering wave C, and the interfering wave F which can act as interfering waves are indicated here.

When the interfering wave search is performed, the gain of the low-noise amplification circuit 22 is set to a predetermined gain, e.g., 21 db. Interfering waves are detected while changing the reception frequency band. While controlling the local transmission circuit 24, the search processing unit 29 (FIG. 3) changes the reception band, receives a signal in the changed reception band, and, once the signal is received, maintains the frequency and signal strength that were set at that time in association therewith. In the interfering wave search, the frequency where the interfering wave is present and the signal strength of the interfering wave are detected.

In the example illustrated in FIG. 8, the frequency where the interfering wave is located and the signal strength thereof are detected while changing the reception frequency band from the frequency A side to the frequency B side in sequence. In the example illustrated in FIG. 8, the interfering wave A at the signal strength P1 is detected when searching at the frequency A, and the interfering wave B at the signal strength P1 is detected when searching at the frequency B. The interfering wave C at the signal strength P2 is detected when searching at the frequency C, and the interfering wave F at the signal strength P2 is detected when searching at the frequency F.

Here, when the interfering wave affecting the terminal 11 has a signal strength of at least “−60 dB”, the interfering wave A and the interfering wave B are set as the interfering waves as the result of the interfering wave search, in the example illustrated in FIG. 8. In order to detect such interfering waves, information on the interfering wave is obtained in step S13.

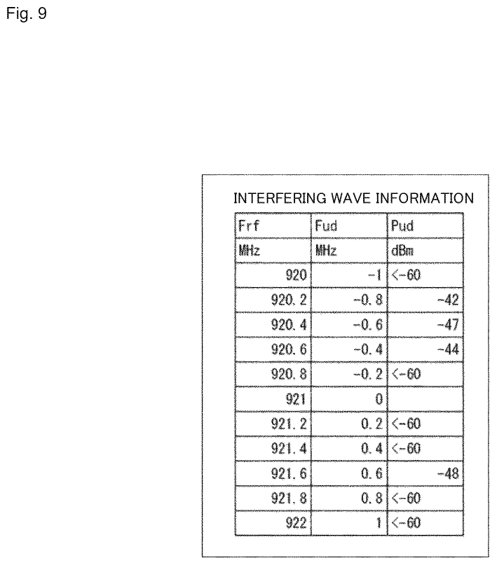

When the information obtained as the information on the interfering wave is collected into a table, a table such as that illustrated in FIG. 9 can be created. The table of interfering wave information (called an “interfering wave information table” hereinafter as appropriate) is a table in which the frequency of the interfering wave (Frf), a difference obtained by subtracting the frequency of the desired wave from the frequency of the interfering wave (Fud), and the strength of the interfering signal (detected signal) (Pud) are associated with each other. The table in FIG. 9 assumes that the frequency of the desired wave is 921 MHz.

In the interfering wave information table in FIG. 9, for example, a Fud of “−1” (=920−921) and a Pud of “>−60” (less than or equal to 60 db) are denoted in association with the frequency Frf of the interfering wave, namely “920”. A Fud of “−0.8” (=920.2−921) and a Pud of “−42” are denoted in association with the frequency Frf of the interfering wave, namely “920.2”. Hereinafter, in the interfering wave information, the difference Fud and the strength Pud according to the interfering wave frequency Frf are denoted in association with each other.

When the interfering wave information table, such as that illustrated in FIG. 9, is created in step S13 (FIG. 6), the sequence moves to step S14. In step S14, the third intermodulation distortion (IM3) for each frequency combination is calculated from the interfering wave information. IM3 will be briefly described here.

For example, when basic signals having two frequencies f1 and f2 near each other are input to a non-linear circuit (e.g., an amplification circuit or the like), IM3 may occur due to the non-linearity of the non-linear circuit. In such a case, the non-linear circuit outputs two signals having a frequency 2f1-f2 and a frequency 2f2-f1, separately from the two basic signals having the frequencies f1 and f2. The two signals having the frequency 2f1-f2 and the frequency 2f2-f1 in this manner are called third intermodulation distortion (IM3).

As described with reference to FIG. 2, the modulation wave E, which is IM3, occurs in the same band as the desired wave. The modulated wave E therefore cannot be removed easily with a filter or the like, and is not easy to remove. This produces noise and the like in the desired wave, which affects the reception of the desired wave in the terminal 11 and leads to a drop in the reception quality of the desired wave.

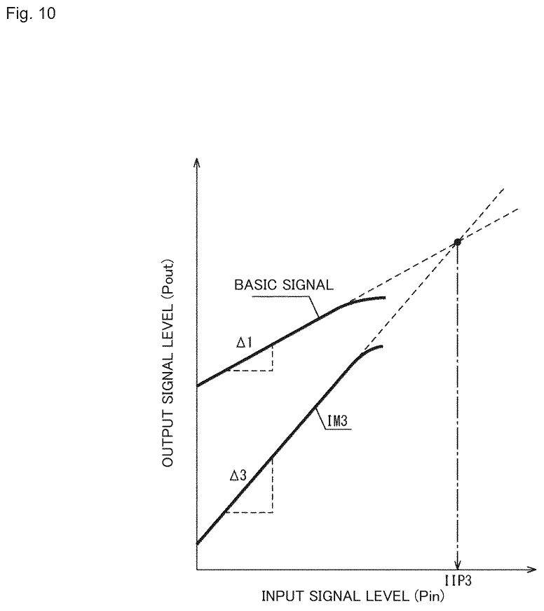

When the basic signals having the two frequencies f1 and f2 near each other is input to the non-linear circuit, and a change in an output signal level (Pout) between the output basic signals (the signals having the frequencies f1 and f2) and the two IM3 having the frequency 2f1-f2 and the frequency 2f2-f1, relative to the input signal level (Pin) of the basic signal input, is indicated, a graph such as that illustrated in FIG. 10, for example, can be obtained.

As can be seen from the graph illustrated in FIG. 10, in a region where the input signal level (Pin) is low, the output signal level of the basic signals is very high compared to the level of IM3. However, in a region where the changes in the output signal levels of the basic signals and IM3 are linear, the level of IM3 rises by 3 dB every time the output signal level of the basic signals rises by 1 dB. Therefore, it can be seen that in a region where the input signal level (Pin) is high, the output signal level of the basic signals and the level of IM3 approach each other, and IM3 has an increased effect on the basic signals.

In a region where the changes in the output signal level of the basic signals and the IM3 are linear, the input signal level at a point where (i) a straight line indicating the change in the output signal level of the basic signals and (ii) a straight line indicating the change in the output signal level of IM3 intersect is called a third order input intercept point (IIP3). The IIP3 indicates the device characteristics (linearity) of the non-linear circuit, and furthermore changes according to various parameters, such as the frequency of the input signal, the power supply voltage applied to the non-linear circuit, the ambient temperature during operation, and the like.

IM3 is determined by the following Formula (1), from the value of IIP3 and Pud (the strength of the interfering wave in FIG. 9).

$$IM 3 = IIP 3 + 2 \times ( Pub 1 - IIP 3 ) + ( Pub 2 - IIP 3 ) \qquad ( 1 )$$

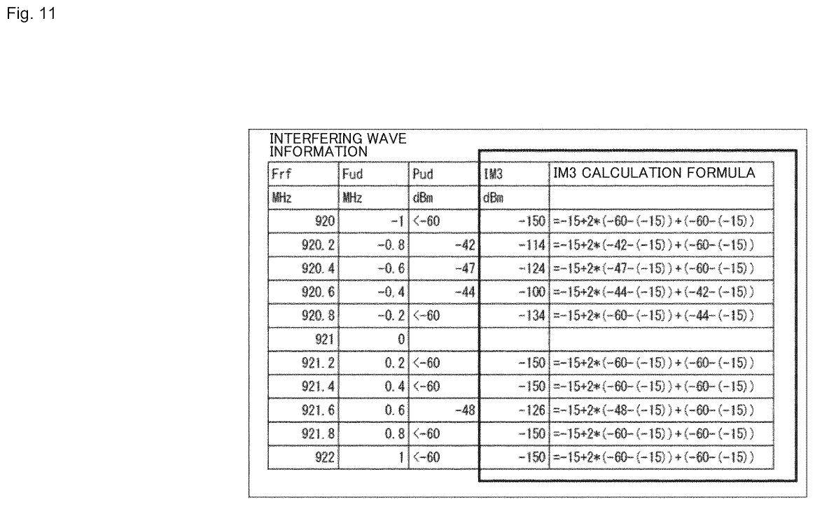

FIG. 11 is a table in which the value of IM3 calculated based on Formula (1) and the calculation formula are combined with the interfering wave information table in

FIG. 9. The part within the bold square in FIG. 11 is the part added to the interfering wave information table.

For example, the IM3 with an Frf of 920.2 is “−114”, and the calculation formula at that time is “−15+2×(−42−(−15))+(−60−(−15))”. The IM3 denoted where Frf is 920.2 is a value corresponding to a combination of an interfering wave having a frequency of 920.2 MHz and an interfering wave having a frequency of 920 MHz. If the value denoted for Pub is “<−60”, “−60” is substituted.

For example, the IM3 with an Frf of 920.4 is “−124”, and the calculation formula at that time is “−15+2×(−47−(−15))+(−60−(−15))”. The IM3 denoted where Frf is 920.4 is a value corresponding to a combination of an interfering wave having a frequency of 920.4 MHz and an interfering wave having a frequency of 920 MHz.

In step S14 (FIG. 6), the IM3 is calculated for each frequency combination of interfering wave candidates denoted in the interfering wave information table. Note that the table in FIG. 11 is provided for explanatory purposes. It is not necessary for the IM3 calculation formula to be written in the table itself, and the configuration may be such that the same processing as that described hereinafter is performed in a method other than one in which a table is created.

In step S15 (FIG. 6), a frequency combination (Fud1, Fud2) where the IM3 is highest is specified. Referring again to the interfering wave information table in which the value of IM3 is added, indicated in FIG. 11, it can be seen that the highest value of IM3 is “−100”, and the frequency combination in which IM3 is “−100” is Pud=−44 dBm, with Frf=920.6 MHz, and Pud=−42 dBm, with Frf=920.2 MHz.

In this case, information that the influence of the IM3 from two waves, namely an interfering wave of Pud=−44 dBm and Frf=920.6, and an interfering wave of Pud=−42 dBm and Frf=920.2 MHz (where the value of IM3 is the highest), can be obtained from the table shown in FIG. 11.

In step S16 (FIG. 6), the values of level Pud1 and level Pud2 of the interfering waves at Fud1 and Fud2 are input to the reception characteristic table, and the IM3 at each VAGC is calculated. In the above example, assuming that the level Pud1=−44 dBm and the level Pud2=−42 dBm, these values are substituted into Formula (1), the value of IIP3 obtained from the receiver performance table in FIG. 7 is substituted into Formula (1), and the IM3 produced by the detected interfering wave is calculated.

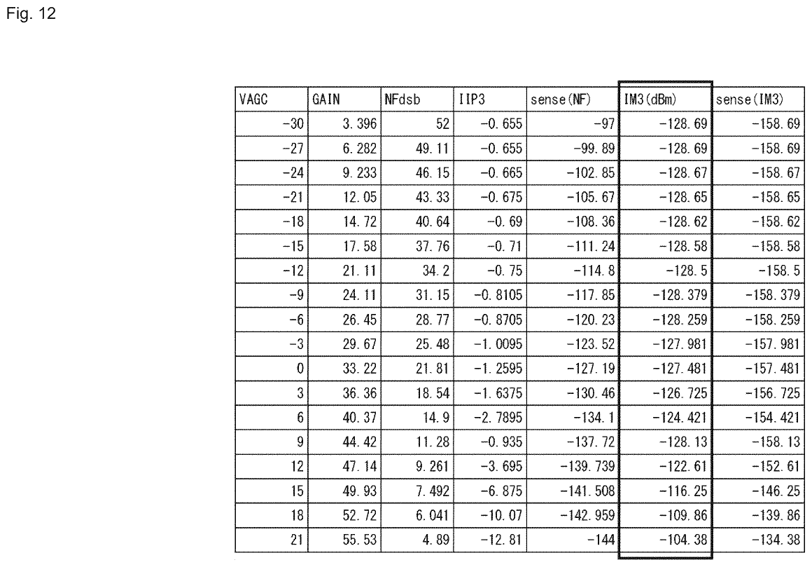

FIG. 12 illustrates a table in which the IM3 (dBm) calculated from the information of the two detected interfering waves is added to the receiver performance table. FIG. 12 is an example in which a sensitivity (Sense (NF)) determined by the NF (noise figure) and a sensitivity (Sense (IM3)) determined by the IM3 (distortion) are also calculated and added. Sense (NF) is calculated by the following Formula (2), and Sense (IM3) is calculated by the following Formula (3).

$$Sense ( NF ) = - 144 + NFdsb - 5 \qquad ( 2 )$$

$$Sense ( IM 3 ) = IM 3 - 30 \qquad ( 3 )$$

For example, the IM3 when VAGC=−30 and the IIP3=−0.655 is denoted as −128.69 (=−0.655+2×(−44−(−0.655))+(−42−(−0655)))), Sense (NF) is denoted as −97(=−144+52−5), and Sense (IM3) is denoted as −158.69(=−128.69−30).

Additionally, for example, the IM3 when VAGC=−27 and the IIP3=−0.655 is denoted as −128.69, Sense (NF) is denoted as −99.89, and Sense (IM3) is denoted as −158.69. In this manner, Sense (NF), IM3, and Sense (IM3) are calculated for each VAGC, and are denoted in the receiver characteristic table.

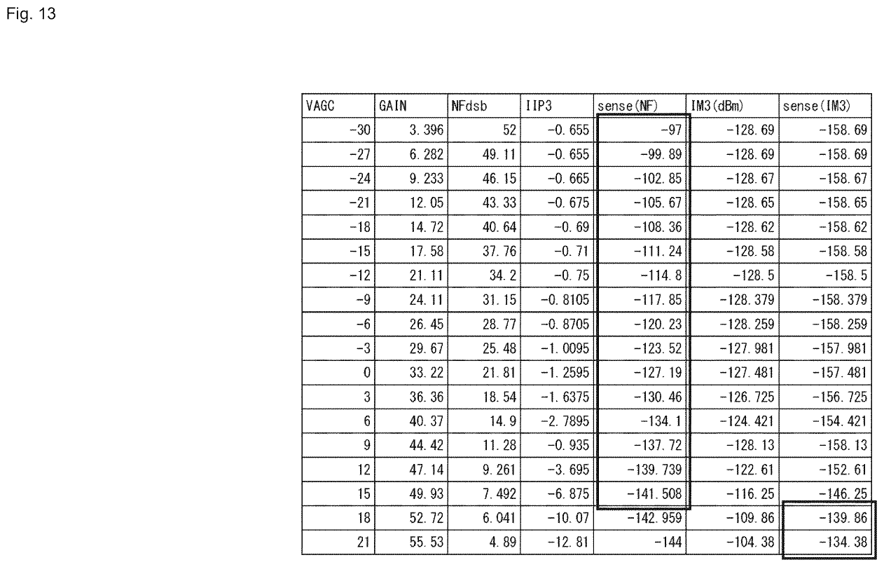

In step S17 (FIG. 6), processing for selecting the greater value among Sense (NF) and Sense (IM3) is performed at each VAGC. FIG. 13 is a table in which a rectangle indicating the result of the processing for selecting the greater value among Sense (NF) and Sense (IM3) has been added to the receiver performance table in FIG. 12. In the receiver performance table in FIG. 13, the part within the rectangle indicates the selected value.

It can be seen that Sense (NF) is selected when the VAGC is −30 to 15, and Sense (IM3) is selected when the VAGC is 18 and 21.

In step S18 (FIG. 6), the gain (VAGC) of the low-noise amplification circuit 22 having the lowest sensitivity in the receiver performance table is specified. In step S17, the gain of the low-noise amplification circuit 22 where the selected value switches from the value of Sense (NF) to the value of Sense (IM3) is set to the gain (VAGC) of the low-noise amplification circuit 22 specified in step S18. In the case illustrated in FIG. 13, VAGC=15 is selected. When VAGC=15 is selected, Sense (NF) becomes −141.508 dBm, which is the lowest value, that is, a favorable value.

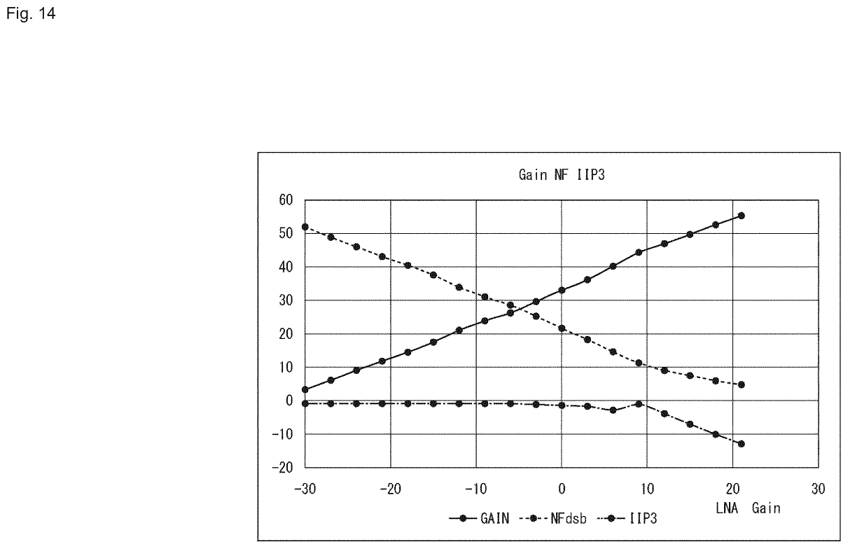

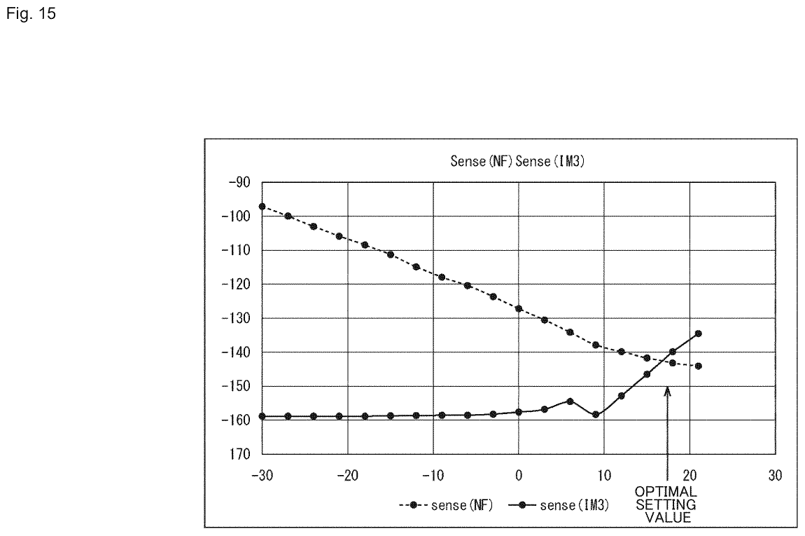

The processing in steps S17 and S18 will be described with reference to FIGS. 14 and 15. FIG. 14 is a graph illustrating changes in GAIN, NFdsb, and IIP3 when the gain (VAGC) of the low-noise amplification circuit 22 is changed. FIG. 14 expresses the receiver performance table illustrated in FIG. 7 as a graph, for example.

The horizontal axis of the graph in FIG. 14 represents the gain of the low-noise amplification circuit 22 (LNA Gain), and the vertical axis represents dB. It can be seen that the value of the noise figure (NFdsb) decreases as the gain (VAGC) of the low-noise amplification circuit 22 is lowered (as the graph progresses to the right). The noise figure (NFdsb) is a value which indicates increased degradation as the value decreases.

It can be seen that the value of the intermodulation distortion intercept point (IIP3) increases as the gain (VAGC) of the low-noise amplification circuit 22 is lowered (as the graph progresses to the right). The intermodulation distortion intercept point (IIP3) is a value which indicates reduced (better) distortion as the value increases. In this manner, it can be seen from the graph in FIG. 14 that the value of the noise figure and the value of the intermodulation distortion intercept point change in response to the gain of the low-noise amplification circuit 22.

FIG. 15 is a graph illustrating changes in sensitivity when the gain of the low-noise amplification circuit 22 is changed. The horizontal axis of the graph in FIG. 15 represents the gain of the low-noise amplification circuit 22 (LNA Gain), and the vertical axis represents the value of Sense (NF) or Sense(IM3). The graph illustrated in FIG. 15 is a graph for a predetermined Pud (signal strength of the interfering wave), and the descriptions will continue here assuming the graph in FIG. 13 is plotted on the graph in FIG. 15.

From the graph in FIG. 15, it can be seen that the sensitivity Sense (NF) of the noise figure decreases as the gain of the low-noise amplification circuit 22 decreases (as the graph progresses to the right), and the sensitivity worsens. On the other hand, it can be seen that the sensitivity Sense (IM3) of the third intermodulation distortion increases as the gain of the low-noise amplification circuit 22 decreases (as the graph progresses to the right), and the sensitivity improves.

In the graph in FIG. 15, the gain of the low-noise amplification circuit 22 corresponding to the point of intersection between the sensitivity Sense (NF) of the noise figure and the sensitivity Sense (IM3) of the third intermodulation distortion corresponds to an optimal gain, and is a gain at which the effect of the interfering wave can be minimized. If the gain corresponding to this point of intersection is searched out from the table in FIG. 13, the search can be performed through the processing of steps S17 and S18 being performed. In other words, the point where the value selected in step S17 switches from the value of Sense (NF) to the value of Sense (IM3) is searched out, and the gain of the low-noise amplification circuit 22 where the switch occurs corresponds to the point of intersection in the graph in FIG. 15.

Note that if the configuration is such that the gain of the low-noise amplification circuit 22 can be adjusted in 1-dB increments, the gain corresponding to the point of intersection can be set, and such a configuration may therefore be used. However, if the configuration is such that the gain is adjusted in 3-dB increments as in the example, the gain that can be adjusted closest to the intersection point is set as the gain of the low-noise amplification circuit 22.

The gain of the low-noise amplification circuit 22 set in this manner is a gain capable of suppressing the effect of noise and suppressing the effect of third intermodulation distortion. In other words, the gain is the gain of the low-noise amplification circuit 22 that can suppress the effect of interfering waves the most, and by setting the gain of the low-noise amplification circuit 22 to such a gain, the desired wave can be received having minimized the effect of the interfering waves.

The search processing unit 29 (FIG. 3) searches for interfering waves by executing the processing of the flowchart in FIG. 6, and sets the low-noise amplification circuit 22 to a gain unlikely to be affected by interfering waves. After the gain of the low-noise amplification circuit 22 is set to the gain set by the search processing unit 29, the signal from the base station 12 (the desired wave) is received. Accordingly, the desired wave can be received with the effects of the interfering wave reduced.

Although the gain of the low-noise amplification circuit 22 changes, this change is processing that can be performed only on the terminal 11 side. The gain suitable for the circumstances around the terminal 11 can be set for each terminal 11. In addition, a setting for reducing the effects of interfering waves can be made without bidirectional communication with the base station 12.

According to the present technique, interfering waves can be detected, a suitable gain can be set, and signals can be received at the set gain, even in a situation where a plurality of devices which produce interfering waves are present near the terminal. This makes it possible to reduce intermodulation distortion, and demodulate the signal from the base station.

### <Recording Medium>

The above-described series of steps of processing may be performed by hardware or software. When the series of steps of processing is performed by software, a program of the software is installed in a computer. Here, the computer includes, for example, a computer built in dedicated hardware and a general-purpose personal computer in which various programs are installed to be able to execute various functions.

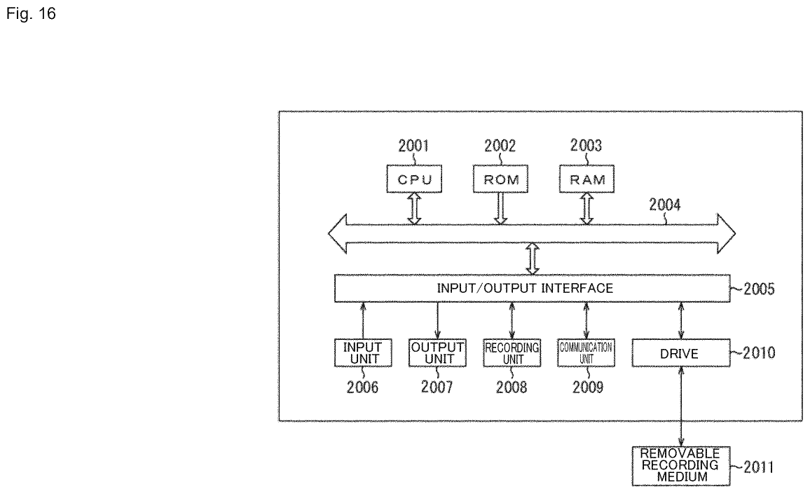

FIG. 16 is a block diagram illustrating an example of a hardware configuration of a computer that executes the above-described steps of processing by a program. In the computer, a central processing unit (CPU) 2001, a read only memory (ROM) 2002, and a random access memory (RAM) 2003 are connected to each other by a bus 2004. An input/output interface 2005 is further connected to the bus 2004. An input unit 2006, an output unit 2007, a storage unit 2008, a communication unit 2009, and a drive 2010 are connected to the input/output interface 2005.

The input unit 2006 is constituted by a keyboard, a mouse, a microphone, or the like. The output unit 2007 includes a display, a speaker, and the like. The storage unit 2008 is a hard disk, non-volatile memory, or the like. The communication unit 2009 is a network interface or the like. The drive 2010 drives a removable medium 2011 such as a magnetic disk, an optical disc, a magneto-optical disk, or a semiconductor memory.

In the computer that has the above configuration, for example, the CPU 2001 executes the above-described series of processing by loading a program stored in the storage unit 2008 into the RAM 2003 via the input/output interface 2005 and the bus 2004 and executing the program.

The program executed by the computer (the CPU 2001) can be recorded on, for example, the removable medium 2011 serving as a package medium for supply. The program can also be provided via a wired or wireless transmission medium such as a local area network, the Internet, or digital satellite broadcasting.

In the computer, by mounting the removable medium 2011 on the drive 2010, it is possible to install the program in the storage unit 2008 via the input/output interface 2005. The program can be received by the communication unit 2009 via a wired or wireless transfer medium to be installed in the storage unit 2008. In addition, the program may be installed in advance in the ROM 2002 or the storage unit 2008.

Note that the program executed by a computer may be a program that performs processing chronologically in the order described in the present specification or may be a program that performs processing in parallel or at a necessary timing such as a called time.

“System” as used herein refers to an entire device constituted by a plurality of devices.

The effects described in the present specification are merely examples and are not intended to be limiting, and other effects may be obtained.

Embodiments of the present technique are not limited to the above-described embodiment, and various modifications can be made within the scope of the present technique without departing from the essential spirit of the present technique.

The present technique can also be configured as follows.

(1)

A receiving device including:
a low-noise amplifying unit into which a received signal is input; and
a search processing unit that searches for an interfering wave and sets a gain of the low-noise amplifying unit to reduce an effect of the interfering wave.
   (2)

The receiving device according to (1),
wherein when the gain is changed, a gain, at which a sensitivity of a noise figure of the interfering wave and a sensitivity of third intermodulation distortion (IM3) of the interfering wave intersect, is set to the gain of the low-noise amplifying unit.
   (3)

The receiving device according to (2),
wherein the receiving device holds a performance table, in which the gain of the low-noise amplifying unit is associated with the noise figure and an intermodulation distortion intercept point (IIP3) at the gain.
   (4)

The receiving device according to (3),
wherein the low-noise amplifying unit is fixed to a predetermined gain, a frequency of the received signal is changed, and the interfering wave is detected, and when the interfering wave is detected, the IM3 is calculated using a frequency and a signal strength of the interfering wave.
   (5)

The receiving device according to (4),
wherein a combination of frequencies of interfering waves, each being the interfering wave, at which a value of the IM3 is highest, is specified, and using a signal strength of the specified interfering wave and a value in the performance table, the IM3 is calculated for each of gains each being the gain, denoted in the performance table.
   (6)

The receiving device according to (5),
wherein for each of the gains denoted in the performance table, a greater of the sensitivity of the noise figure and the sensitivity of the IM3 is selected, a gain that changes the sensitivity of the noise figure to the sensitivity of the IM3 is determined, and the gain determined is set to the gain of the low-noise amplifying unit.
   (7)

The receiving device according to any one of (1) to (6),
wherein the gain is set by the search processing unit at a point in time before receiving a signal from a base station.
   (8)

A receiving method including: by a receiving device, which includes a low-noise amplifying unit into which a received signal is input, searching for an interfering wave and setting a gain of the low-noise amplifying unit to reduce an effect of the interfering wave.

(9)

A program for causing a computer, which controls a receiving device including a low-noise amplifying unit into which a received signal is input, to perform processing including a step of searching for an interfering wave and setting a gain of the low-noise amplifying unit to reduce an effect of the interfering wave.

### REFERENCE SIGNS LIST

1 Information processing system
11 Terminal
12 Base station
13 Transmitter
21 Antenna
22 Low-noise amplification circuit
23 Mixer circuit
24 Local oscillation circuit
25 LPF
26 Amplification circuit
28 Signal processing unit
29 Search processing unit

1. A receiving device comprising:
a low-noise amplifying unit into which a received signal is input; and
a search processing unit that searches for an interfering wave and sets a gain of the low-noise amplifying unit to reduce an effect of the interfering wave.

2. The receiving device according to claim 1,
wherein when the gain is changed, a gain, at which a sensitivity of a noise figure of the interfering wave and a sensitivity of third intermodulation distortion (IM3) of the interfering wave intersect, is set to the gain of the low-noise amplifying unit.

3. The receiving device according to claim 2,
wherein the receiving device holds a performance table, in which the gain of the low-noise amplifying unit is associated with the noise figure and an intermodulation distortion intercept point (IIP3) at the gain.

4. The receiving device according to claim 3,
wherein the low-noise amplifying unit is fixed to a predetermined gain, a frequency of the received signal is changed, and the interfering wave is detected, and when the interfering wave is detected, the IM3 is calculated using a frequency and a signal strength of the interfering wave.

5. The receiving device according to claim 4,
wherein a combination of frequencies of interfering waves, each being the interfering wave, at which a value of the IM3 is highest, is specified, and using a signal strength of the specified interfering wave and a value in the performance table, the IM3 is calculated for each of gains each being the gain, denoted in the performance table.

6. The receiving device according to claim 5,
wherein for each of the gains denoted in the performance table, a greater of the sensitivity of the noise figure and the sensitivity of the IM3 is selected, a gain that changes the sensitivity of the noise figure to the sensitivity of the IM3 is determined, and the gain determined is set to the gain of the low-noise amplifying unit.

7. The receiving device according to claim 1,
wherein the gain is set by the search processing unit at a point in time before receiving a signal from a base station.

8. A receiving method comprising: by a receiving device, which includes a low-noise amplifying unit into which a received signal is input, searching for an interfering wave and setting a gain of the low-noise amplifying unit to reduce an effect of the interfering wave.

9. A program for causing a computer, which controls a receiving device including a low-noise amplifying unit into which a received signal is input, to perform processing comprising a step of searching for an interfering wave and setting a gain of the low-noise amplifying unit to reduce an effect of the interfering wave.
